(19) United States
(12) Patent Application Publication
(10) Pub. No.: US 2014/0301581 A1
(43) Pub. Date: Oct. 9, 2014

(54) Laser Welded Speaker

(71) Applicant: MERRY ELECTRONICS (SUZHOU) CO., LTD., Suzhou City (CN)

(72) Inventors: Jui Cheng CHANG, Suzhou City (CN); Li-Hsin WU, Suzhou City (CN)

(73) Assignee: MERRY ELECTRONICS (SUZHOU) CO., LTD., Suzhou City (CN)

(21) Appl. No.: 13/856,257

(22) Filed: Apr. 3, 2013

(51) Int. Cl. H04R 19/02

(52) U.S. Cl. CPC H04R 19/02
USPC 381/191

(57) ABSTRACT

A laser welded speaker, including a lower cover, an upper cover fitting with the lower cover, a frame arranged on the lower cover, a lower piece arranged at a bottom of the frame, a magnet arranged in the middle of the lower piece, a pole piece arranged on the magnet, a vibration plate arranged on the frame, and a voice coil fixedly arranged on the vibration plate, the frame is located over the pole piece, the vibration plate is formed of a vibration plate top arc located in the middle and a vibration plate edge located at a periphery, and the vibration plate top arc and the vibration plate edge are fixedly connected together through laser welding. The vibration plate top arc and the vibration plate edge are welded through laser, thereby improving heat-resistant performance of the vibration plate and reducing harm to a human body and environmental pollution.

### BACKGROUND OF THE INVENTION

1. Field of Invention

The present invention relates to the field of speakers, and particularly to a laser welded speaker.

2. Related Art

In a speaker, a vibration plate is an important component. Quality of the vibration plate has a direct hearing on performance and a service life of the speaker. However, the existing production technology has a certain problem. The vibration plate is generally formed of a vibration plate top arc 8 and a vibration plate edge 9, which are adhered together by using glue 11 (FIG. 4). The most part of the vibration plate top arc 8 and edge 9 is made of a material having a smooth surface. Sticking agent volatilization of the glue 11 is limited when the glue 11 is coated on the smooth surface. The glue 11 is a macromolecular material and has poor heat-resistant performance, so when the temperature rises, the strength is poor. Meanwhile, the glue 11 and a solvent matching the glue 11 are smelly and harm respiratory and nervous systems. In order to prevent pollution, the solvent for cleaning the glue 11 needs to be specially reclaimed, thereby increasing the waste processing cost.

At a joint of an upper cover 7 and a lower cover 6 of the speaker, an ultrasonic welding is adopted in the prior art (FIG. 5). However, a weld wire 12 is required in the ultrasonic welding. Many kinds of the weld wires exist, for example, a step type, a mortise type, a cutting type, and a riveting type. Design of the weld wire 12 most depends on factors such as experience of a designer, a thickness of a product, and a shape, so the design of a mechanism is easily affected due to personal factors of the designer so that product quality is unstable.

Therefore, a new speaker capable of overcoming the foregoing disadvantages is required now.

### SUMMARY OF THE INVENTION

The present invention is aimed at providing a speaker, having an upper cover and a lower cover welded through laser.

In order to achieve the foregoing objective, the technical solution adopted by the present invention is: a laser welded speaker, comprising a lower cover, an upper cover fitting with the lower cover, a frame arranged on the lower cover, a lower piece arranged at a bottom of the frame, a magnet arranged in the middle of the lower piece, a pole piece arranged on the magnet, a vibration plate arranged on the frame, and a voice coil fixedly arranged on the vibration plate, where the frame is located over the pole piece, the vibration plate is formed of a vibration plate top arc located in the middle and a vibration plate edge located at a periphery, and the vibration plate top arc and the vibration plate edge are fixedly connected together through laser welding.

Preferably, the upper cover and the lower cover are fixedly connected together through laser welding.

Further, preferably, a welding surface of the upper cover and the lower cover is a plane; one of the upper cover and the lower cover is made of a laser-penetrable material, and the other is made of a laser-absorbable material.

Preferably, one of the vibration plate top arc and the vibration plate edge is made of a laser-penetrable material, and the other is made of a laser-absorbable material.

Preferably, a thickness of the vibration plate top arc is less than a thickness of the vibration plate edge.

Through application of the foregoing technical solution, compared with the prior art, the present invention has the following advantages:

1. In the present invention, the vibration plate top arc and the vibration plate edge are welded through laser, thereby improving heat-resistant performance of the vibration plate and reducing harm to a human body and environmental pollution.

2. In the present invention, the upper cover and the lower cover are welded through laser, and the welding surface of the upper and lower covers are changed to the plane, thereby omitting a step of designing a welding wire, reducing the production cost, and stabilizing the product quality.

### BRIEF DESCRIPTION OF THE DRAWINGS

FIG. 1 is a schematic view of the present invention;

FIG. 2 is a schematic enlarged view A of the present invention;

FIG. 3 is a schematic enlarged view B of the present invention;

FIG. 4 is a schematic enlarged view of an existing vibration plate; and

FIG. 5 is a schematic enlarged view of welding of existing upper and lower covers.

### DETAILED DESCRIPTION OF THE INVENTION

The present invention is further described in the following with reference to embodiments shown in the accompanying drawings.

### Embodiment 1

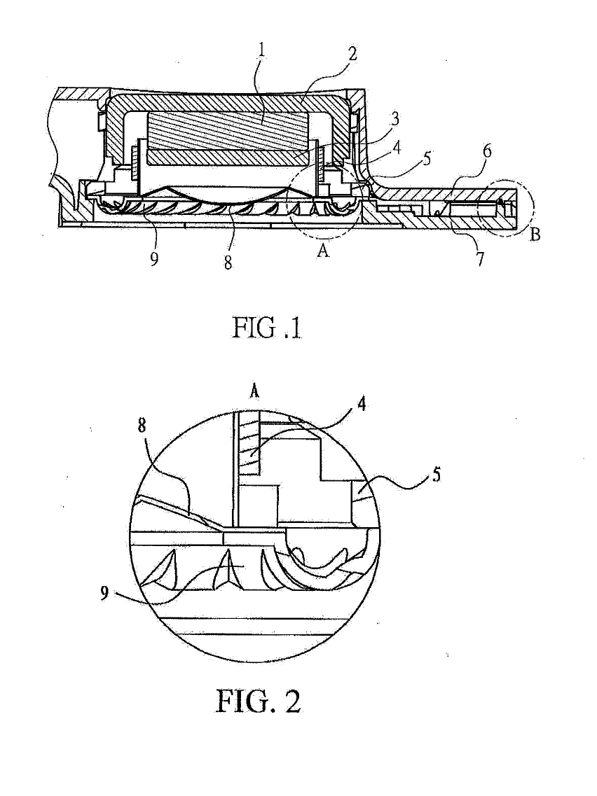

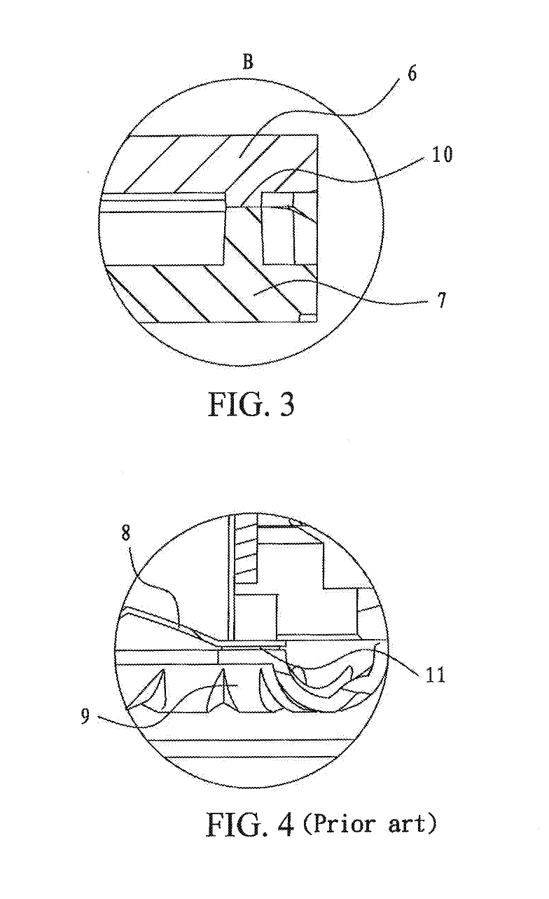

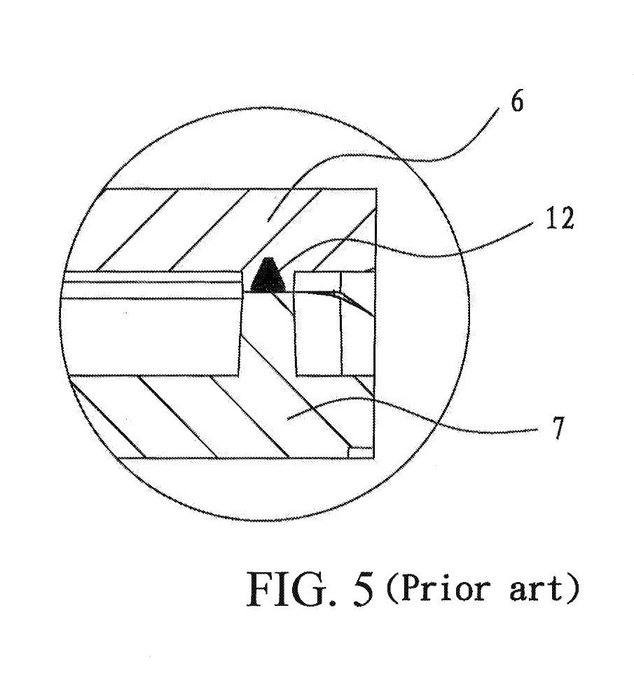

A laser welded speaker shown in FIG. 1 to FIG. 3 includes a lower cover 6, an upper cover 7 fitting with the lower cover 6, a frame 5 arranged on the lower cover 6, a lower piece 2 arranged at a bottom of the frame 5, a magnet 1 arranged in the middle of the lower piece 2, a pole piece 3 arranged on the magnet 1, a vibration plate arranged on the frame 5, and a voice coil 4 fixedly arranged on the vibration plate, where the frame 5 is located over the pole piece 3, the vibration plate is formed of a vibration plate top arc 8 located in the middle and a vibration plate edge 9 located at a periphery, the vibration plate top arc 8 and the vibration plate edge 9 are fixedly connected together through laser welding, the upper cover 7 and the lower cover 6 are fixedly connected together through laser welding, a welding surface 10 of the upper cover 7 and the lower cover 6 is a plane, the upper cover 7 is made of a laser-penetrable material, the lower cover 6 is made of a laser-absorbable material, the vibration plate top arc 8 is made of a laser-penetrable material., the vibration plate edge 9 is made of a laser-absorbable material, and a thickness of the vibration plate top arc 8 is less than a thickness of the vibration plate edge 9.

In this embodiment, the vibration plate top arc 8 and the vibration plate edge 9 are welded through laser, thereby improving heat-resistant performance of the vibration plate and reducing harm to a human body and environmental pollution; the upper cover 7 and the lower cover 6 are welded through laser, and the welding surface of the upper and lower covers are changed to the plane, thereby omitting a step of designing a welding wire, reducing the production cost, and stabilizing the product quality.

### Embodiment 2

A laser welded speaker shown in FIG. 1 to FIG. 3 includes a lower cover 6, an upper cover 7 fitting with the lower cover 6, a frame 5 arranged on the lower cover 6, a lower piece 2 arranged at a bottom of the frame 5, a magnet 1 arranged in the middle of the lower piece 2, a pole piece 3 arranged on the magnet 1, a vibration plate arranged on the frame 5, and a voice coil 4 fixedly arranged on the vibration plate, where the frame 5 is located over the pole piece 3, the vibration plate is formed of a vibration plate top arc 8 located in the middle and a vibration plate edge 9 located at a periphery, the vibration plate top arc 8 and the vibration plate edge 9 are fixedly connected together through laser welding, the upper cover 7 and the lower cover 6 are fixedly connected together through laser welding, a welding surface 10 of the upper cover 7 and the lower cover 6 is a plane, the upper cover 7 is made of a laser-absorbable material, the lower cover 6 is made of a laser-penetrable material, the vibration, plate top are 8 is made of a laser-absorbable material, the vibration plate edge 9 is made of a laser-penetrable material, and a thickness of the vibration plate top arc 8 is less than a thickness of the vibration plate edge 9.

In this embodiment, the vibration plate top arc 8 and the vibration plate edge 9 are welded through laser, thereby improving heat-resistant performance of the vibration plate and reducing harm to a human body and environmental pollution; the upper cover 7 and the lower cover 6 are welded through laser, and the welding surface of the upper and lower covers are changed to the plane, thereby omitting a step of designing a welding wire, reducing the production cost, and stabilizing the product quality.

The foregoing embodiments are intended to illustrate ideas and features of the present invention, and are aimed at making persons skilled in the art know the content of the present invention and implement the present invention, but not limiting the protection scope of the present invention. All equivalent variations and modifications made according to the spirit substance of the present invention should fall within the protection scope of the present invention.

1. A laser welded speaker, comprising:
a lower cover;
an upper cover, fitting with the lower cover;
a frame, arranged between the lower cover and the upper cover;
a vibration plate, fixedly arranged in the frame;
a lower piece, arranged at a bottom of the frame;
a magnet, arranged in the middle of the lower piece;
a pole piece, arranged on the magnet; and
a voice coil, fixedly arranged on the vibration plate;
wherein the frame is located over the lower piece, the vibration plate is formed of a vibration plate top arc located in the middle and a vibration plate edge located at a periphery, and the vibration plate top arc and the vibration plate edge are fixedly connected together through laser welding,
wherein the upper cover and the lower cover are fixedly connected together through laser welding.

2. (canceled)

3. The laser welded speaker according to claim 1, wherein a welding surface of the upper cover and the lower cover is a plane.

4. The laser welded speaker according to claim 1, wherein one of the upper cover and the lower cover is made of a laser-penetrable material, and the other is made of a laser-absorbable material.

5. The laser welded speaker according to claim 1, wherein one of the vibration plate top arc and the vibration plate edge is made of a laser-penetrable material, and the other is made of a laser-absorbable material.

6. The laser welded speaker according to claim 1, wherein a thickness of the vibration plate top arc is less than a thickness of the vibration plate edge.
